(19) United States
(12) Patent Application Publication
(10) Pub. No.: US 2024/0319853 A1
(43) Pub. Date: Sep. 26, 2024

(54) METHOD, APPARATUS, TERMINAL AND STORAGE MEDIUM OF INFORMATION PROCESSING

(71) Applicant: Beijing Zitiao Network Technology Co., Ltd., Beijing (CN)

(72) Inventors: Xinlei Guo, Beijing (CN); Ronghui Zhang, Beijing (CN); Shijie Liu, Beijing (CN)

(21) Appl. No.: 18/575,074

(22) PCT Filed: Sep. 15, 2022
(86) PCT No.: PCT/CN2022/118987

§ 371 Date: Dec. 28, 2023

(30) Foreign Application Priority Data
Sep. 16, 2021 (CN) 202111087709.6

(51) Int. Cl. G06F 3/0484; G06F 3/0481

(52) U.S. Cl. CPC G06F 3/0484; G06F 3/0481

(57) ABSTRACT

The disclosure provides a method, an apparatus, a terminal, and a storage medium of information processing. The method of information processing comprises: in response to a first user receiving an association request for task information of a second user, displaying a first control in a task interface of the first user; and in response to a first predetermined operation on the first control, displaying a task sub-interface. According to embodiments of the disclosure, in response to a first user receiving an association request for task information of a second user, a first control can be displayed in the first user's task interface to remind the first user to view or process the corresponding information in a timely manner.

### CROSS REFERENCE

This application claims priority to the Chinese patent application with application number 202111087709.6, filed on Sep. 16, 2021, entitled “METHOD, APPARATUS, TERMINAL AND STORAGE MEDIUM OF INFORMATION PROCESSING”, the entire contents of which are hereby incorporated into this application by reference.

### FIELD

The present disclosure relates to the field of information, and more particularly to a method, an apparatus, a terminal and a storage media of information processing.

### BACKGROUND

In certain information management interfaces, such as OKR management interfaces encompassing Objective (O) and Key Result (KR) information, collaboration among multiple members or teams is frequently required. This underscores the importance of aligning the information to ensure the successful attainment of overall objectives for all the involved members or teams.

### SUMMARY

To solve the existing problems, the present disclosure provides a method, an apparatus, a terminal and a storage medium of information processing.

The disclosure adopts the following technical solution.

Embodiments of the present disclosure provide a method of information processing. The method of information processing comprises: in response to a first user receiving an association request for task information of a second user, displaying a first control in a task interface of the first user; and in response to a first predetermined operation on the first control, displaying a task sub-interface.

Another embodiment of the present disclosure provides an apparatus of information processing. The apparatus of information processing comprises: a control display module configured to in response to a first user receiving an association request for task information of the second user, display a first control in a task interface of the first user; and an interface display module configured to in response to a first predetermined operation on the first control, display a task sub-interface.

In some embodiments, the present disclosure provides a terminal. The terminal comprises: at least one memory and at least one processor; wherein the at least one memory is for storing program code, the at least one processor is for calling the program code stored in the at least one memory to perform a method of information processing as mentioned above.

In some embodiments, the present disclosure provides a storage medium. The storage medium is for storing program code, the program code for performing the above method of information processing.

According to embodiments of the present disclosure, in response to a first user receiving an association request for task information of a second user, a first control can be displayed in the first user's task interface to remind the first user to view or process the corresponding information in a timely manner.

### BRIEF DESCRIPTION OF THE DRAWINGS

In conjunction with the accompanying drawings and with reference to the following detailed description, the above and other features, advantages and aspects of the various embodiments of the present disclosure will become more apparent. Throughout the drawings, like or similar reference numerals denote like or similar elements. It should be understood that the drawings are illustrative and that elements and elements are not necessarily drawn to scale.

FIG. 1 is a schematic flowchart of a method of information processing according to embodiments of the present disclosure.

FIG. 2 shows a schematic diagram of a task interface and a task sub-interface according to some embodiments.

FIG. 3 shows partial modules for an apparatus of information processing according to some embodiments of the present disclosure.

FIG. 4 is a schematic structural diagram of an electronic device according to embodiments of the present disclosure.

### DETAILED DESCRIPTION

Embodiments of the present disclosure will be described in more detail with reference to the accompanying drawings in the followings. Although certain embodiments of the present disclosure are shown in the drawings, it should be understood that the present disclosure can be implemented in various forms and should not be construed as limited to embodiments set forth herein. On the contrary, these embodiments are provided for a more thorough and complete understanding of the present disclosure. It should be understood that the drawings and embodiments of the present disclosure are for illustrative purposes only and are not intended to limit the scope of the present disclosure.

It should be understood that the various steps described in the method implementation of the present disclosure can be executed in parallel. In addition, the method implementation method can comprise additional steps and/or omit the steps shown. The scope of the present disclosure is not limited in this regard.

The term “comprise(s)” and its variations used in this article are open-ended, i.e. “comprising but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first” and “second” mentioned in the present disclosure are only used to distinguish different apparatuses, modules, or units, and are not used to limit the order or interdependence of the functions performed by these apparatuses, modules, or units.

It should be noted that the modification of “one” mentioned in the present disclosure is illustrative and not restrictive. Those skilled in the art should understand it as “one or more” unless otherwise specified in the context.

The names of the messages or information exchanged between multiple devices in the present implementation are for illustrative purposes only and are not intended to limit the scope of these messages or information.

In some information management interfaces (such as OKR management interface), when task information created by other users @current user, the current user may miss this information, resulting in misalignment of the overall team's goals.

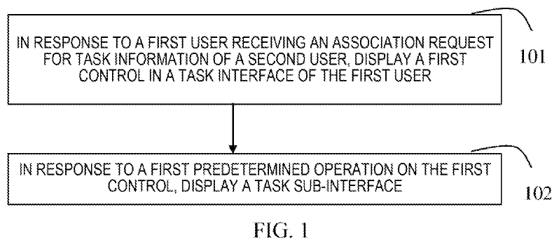

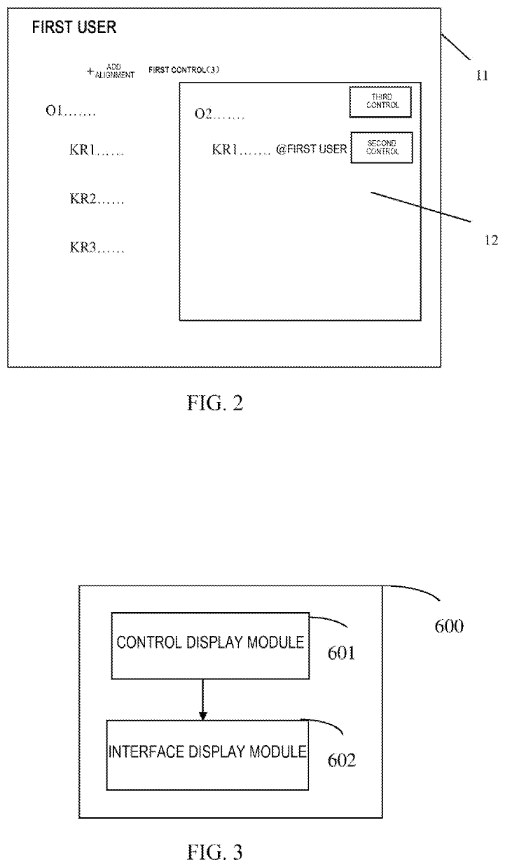

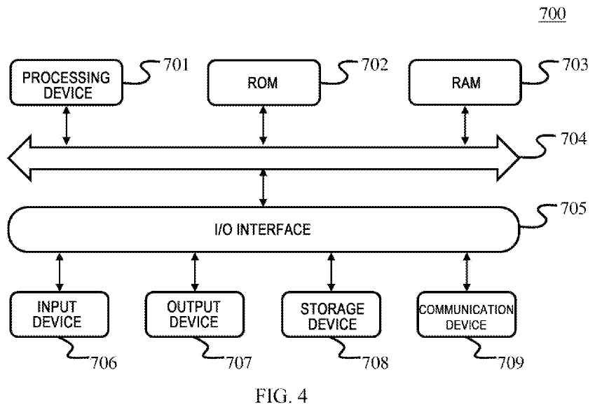

FIG. 1 provides a schematic flowchart of a method of information processing according to embodiments of the present disclosure. FIG. 2 shows a schematic diagram of a task interface and a task sub-interface according to some embodiments of the present disclosure. The method of information processing of the present disclosure may comprise step 101, in response to a first user receiving an association request for task information of a second user, displaying a first control in the task interface 11 of the first user. In some embodiments, different clients may correspond to different users, and generally, information processing systems can be logged in at respective clients through respective users' account information. In some embodiments, the task information comprises but is not limited to OKR information, where O represents objective task information, KR represents key result information or sub-task information, and the objective task information may comprise one or more sub-task information.

In some embodiments, the first client may correspond to the first user, and the second client may correspond to the second user. In some embodiments, “@first user” in the task information created by the second user may be considered to be associated with the task information, but the present disclosure is not limited thereto. In some embodiments, the task interface of the first user is an interface that displays the task information of the first user. In some embodiments, the first control may be, for example, a “Suggest Alignment” control to remind the user to view or process the associated task information in a timely manner.

In some embodiments, the method of the present disclosure may further comprise step 102, in response to a first predetermined operation on the first control, displaying a task sub-interface 12. In some embodiments, the first predetermined operation may be any suitable operation, for example, a click operation, a voice command or the like. In some embodiments, the task sub-interface 12 may be displayed, for example, in a suitable form such as in a form of floating window or the like.

In response to the first user receiving the association request for the task information of the second user, the first control can be displayed in the task interface of the first user to remind the first user to view or process the corresponding information in a timely manner. In addition, information that has not been processed can be displayed on the task sub-interface to facilitate user processing.

In some embodiments, the first control is not displayed when viewing the task interface of other users. In some embodiments, task information is displayed in the task sub-interface 12. In some embodiments, the task sub-interface 12 of the first user is used to display information associated with the first user that has not yet been processed. This facilitates the processing of the corresponding information by the first user. In some embodiments, the task information comprises objective task information (e.g., O in OKR) and/or sub-task information (e.g., KR in OKR), and the objective task information has an association relationship or is associated with the sub-task information.

In some embodiments, the task information comprises a first user identification. For example, “@first user” is displayed in the task information, but the present disclosure is not limited thereto. In some embodiments, the first control is displayed in the predetermined region of the task interface. In some embodiments, the predetermined region is located in the top region of the task interface, for example, near the “add alignment” control above the region where the task information is displayed. In some embodiments, the first control is associated with the objective task information of the first user. In some embodiments, the first control uniquely corresponds to the objective task information of the first user. For example, as described below, regardless of whether “@first user” is used once or multiple times in a piece of objective task information, the first control only reflects one objective task information and does not differ due to multiple associations.

In some embodiments, when associated with the objective task information, the objective task information is displayed in the task sub-interface 12. In some embodiments, when associated with the sub-task information, the sub-task information and the objective task information associated with the sub-task information are displayed in the task sub-interface 12. Therefore, the display of task information is very clear, which facilitates users to complete the corresponding goals according to the guidance of the corresponding task information.

In some embodiments, a second control corresponding to the task information is also displayed in the task sub-interface 12. In some embodiments, each associated task information corresponds to a second control, so that the corresponding task information can be processed with the second control. In some embodiments, the second control can be, for example, an “alignment” control. In some embodiments, the second control is beneficial for guiding user operations, thereby improving user experience.

In some embodiments, the disclosed method of information processing further comprises: when receiving an association request related to the objective task information, displaying the second control in an association region of the objective task information in the task sub-interface. In some embodiments, when receiving an association request related to the sub-task information, determining the objective task information having the association relationship with the sub-task information, and displaying the second control in the association region of the objective task information of the task sub-interface. For example, one piece of objective task information corresponds to one second control. Thus, it is convenient to operate the second control at the level of the objective task information.

In some embodiments, the method of information processing of the present disclosure further comprises: in response to the task information of the second user having been associated with a first objective task information of the first user, forgoing displaying the task information of the second user in task sub-interface corresponding to the first objective task information. For example, if “@first user” is used in the objective task information O1 of the second user, and the objective task information O1 has been aligned with the objective task information O2 of the first user, the objective task information O1 of the second user is not displayed in the task sub-interface corresponding to the objective task information O2 of the first user. In this way, alignment into a loop can be avoided, and unnecessary consumption of information display space can be reduced.

In some embodiments, the method of information processing of the present disclosure further comprises: determining second objective task information of the first user that is unassociated with the task information of the second user, and displaying the task information of the second user in task sub-interface corresponding to the second objective task information. For example, if “@first user” is used in the objective task information O1 of the second user and the objective task information O1 has been aligned with the objective task information O2 of the first user, the objective task information O1 of the second user can be displayed in the task sub-interface corresponding to the objective task information O3 of the first user.

In some embodiments, in response to a second predetermined operation on the second control, displaying the task information in the task sub-interface 12 is terminated. In some embodiments, the second predetermined operation may comprise a click operation, a voice command or any other suitable operation. For example, after the second control is triggered, which indicates that the corresponding task information has been processed (e.g., aligned), and since the task information has been aligned, so that the task information has no need to be displayed in the sub-task interface 12, on the one hand, to save the display space of the sub-task interface, but also to avoid interference with the user's other task information to be processed.

In some embodiments, in response to a second predetermined operation of the second control, a user identification of the second user is displayed in the task interface of the first user; optionally, the user identification of the second user is displayed in a region associated with the objective task information corresponding to the first control.

In some embodiments, a third control corresponding to the second client is also displayed in the task sub-interface 12. In some embodiments, the first user may be associated with multiple pieces of task information of the second user. In order to improve the efficiency of information processing, there may be a third control corresponding to the second user in the task sub-interface, which facilitates the processing operation of the associated task information of the second user. In some embodiments, the third control may be, for example, an “ignore” control.

In some embodiments, in response to a third predetermined operation on the third control, displaying the task information of the second user in the task sub-interface 12 is terminated. In some embodiments, the third predetermined operation may comprise any suitable operation such as a click operation and a voice command, etc. For example, taking the “ignore” control as an example of the third control, when the third control is triggered, which indicates that the current user does not pay attention to the task information of the second user, so the task information of the second user is no longer displayed in the task sub-interface. In this way, in the task sub-interface, not only can the task information be processed, but also the task information can be processed for specific users, which is conducive to improving the user experience. In some embodiments, if the task information of a specific user (such as the second user) has been ignored, even if the first user is associated with the task information of the specific user later, the task information of the specific user will not be reminded in the first control or displayed in the task sub-interface.

In some embodiments, predetermined information corresponding to the number of pieces of task information displayed in the task sub-interface is further displayed near the first control. In some embodiments, the predetermined information may comprise but is not limited to numbers. In this way, before the first control is triggered, the user can see the number of pieces of task information to be processed, which also facilitates the user's operation. In some embodiments, when the number of pieces of associated task information increases, the predetermined information will also change accordingly, for example, adding a piece of associated task information and the number adding one. On the other hand, as the processing of the task information displayed in the task sub-interface, the number of pieces of the task information displayed in the task sub-interface is changed and the predetermined information will also be changed accordingly. In this way, the consistency and accuracy of the overall content are ensured. In some embodiments, if “@current user” is used multiple times in the same task information (comprising objective task information and sub-task information), only one change in the predetermined information is counted.

In some embodiments, the method of information processing of the present disclosure further comprises: determining whether the objective task information and sub-task information contain an association request; determining the predetermined information based on the number of pieces of the objective task information containing the association request. For example, in the same OKR information, if “@first user” is used in both of the objective task information O and the subtask information KR, the predetermined information is determined only according to the number of pieces of objective task information O at this time. In some embodiments, the predetermined information is determined according to the number of pieces of objective task information comprising sub-task information associated with the association request. For example, in some embodiments, “@first user” is only used in the sub-task information KR, at this time, the predetermined information can be determined according to the number of pieces of objective task information O associated with the sub-task information KR.

In some embodiments, when there is no task information in the task sub-interface, the task sub-interface is closed, and the first control is not displayed in the task interface. When there is no task information in the task sub-interface, which indicates that there is no task information that needs to be viewed or processed, there is no need to display the task sub-interface, so the task sub-interface is closed. In addition, the first control is no longer needed to remind the existence of task information to be processed, so the first control can disappear and not be displayed, saving the space for displaying the task interface.

In some embodiments, in response to a first user receiving an association request for task information of a second user, displaying a first control in a task interface of the first user comprises: in response to the first user having a permission to the task information, displaying the first control in the task interface of the first user. In some embodiments, the task information of the second user may be set with permission (e.g., permission for viewing). If the current user does not have permission for the corresponding task information, even if he/she is associated with the task information, there is no need to remind the first user through the first control. Only for the task information for which the first user has permission, the first user is reminded to view or process it through the first control, so that a substantial reminding effect can be achieved.

In some embodiments, displaying the task information in the task sub-interface comprises: in response to the first user having a permission to the task information, displaying the task information in the task sub-interface. If the current user does not have permission for the corresponding task information, even if she/he is associated with the task information, it is not necessary to display it in the task sub-interface. Only the task information for which the first user has permission is displayed in the task sub-interface to facilitate processing by the first user.

In some embodiments, in the sub-task interface 12, the task information is sorted according to the user to whom the task information belongs. For example, the task information of a certain user associated with the first user is displayed first, and then the task information of another user associated with the first user is displayed. As for the sorting order of other users, the task information of the first user's immediate superior can be ranked first, followed by other superiors and colleagues. In this way, the task information most closely associated with the first user can be ranked first, which is conducive to the user's priority viewing and processing.

In some embodiments, when the current user has aligned the task information of a particular user, if the particular user modifies the task information and the modified task information is associated with the current user again, the modified task information will not be reminded by the first control, it will not be displayed again in the task sub-interface.

Embodiments of the present disclosure also provides an apparatus of information processing 600. The apparatus of information processing 600 comprises a control display module 601 and an interface display module 602. In some embodiments, the control display module is configured to in response to a first user receiving an association request for task information of the second user, display a first control in a task interface of the first user. The interface display module is configured to in response to a first predetermined operation on the first control, display a task sub-interface.

It should be understood that the method of information processing described herein also applies to the apparatus of information processing 600, for simplicity, not described in detail herein.

In some embodiments, task information is displayed in the task sub-interface, the task information comprising objective task information and/or sub-task information, and the objective task information having an association relationship with the sub-task information. In some embodiments, the task information comprises a first user identification. In some embodiments, the first control is displayed in a predetermined region of the task interface, and the first control is associated with the objective task information of the first user. In some embodiments, the first control uniquely corresponds to the objective task information of the first user. In some embodiments, when receiving an association request related to the objective task information, the objective task information is displayed in the task sub-interface; or, when receiving an association request related to the sub-task information, the sub-task information is displayed in the task sub-interface, and the objective task information having the association relationship with the sub-task information is displayed. In some embodiments, the control display module is further configured to when receiving an association request related to the objective task information, display the second control in an association region of the objective task information in the task sub-interface; or, when receiving an association request related to the sub-task information, determining the objective task information having the association relationship with the sub-task information, and displaying the second control in the association region of the objective task information of the task sub-interface. In some embodiments, the task information comprises objective task information and/or sub-task information, and the interface display module is further configured to in response to the task information of the second user having been associated with a first objective task information of the first user, forgo displaying the task information of the second user in task sub-interface corresponding to the first objective task information. In some embodiments, the interface display module is further configured to determine second objective task information of the first user that is unassociated with the task information of the second user, and displaying the task information of the second user in task sub-interface corresponding to the second objective task information. In some embodiments, in response to a second predetermined operation on the second control, displaying the task information in the task sub-interface is terminated. In some embodiments, in response to a third predetermined operation on the third control, displaying the task information of the second user in the task sub-interface is terminated. In some embodiments, predetermined information corresponding to the number of pieces of task information displayed in the task sub-interface is further displayed near the first control. In some embodiments, the task information comprises objective task information and/or sub-task information, the objective task information having an association relationship with the sub-task information; the apparatus further comprises a predetermined information determination module, configured to: determine whether the objective task information and sub-task information contain an association request; determine the predetermined information based on the number of pieces of the objective task information containing the association request; or determine the predetermined information based on the number of pieces of objective task information associated with the sub-task information containing the association request. In some embodiments, when the task information is not contained in the task sub-interface, the task sub-interface is closed, and the first control is not displayed in the task interface. In some embodiments, in response to a first user receiving an association request for task information of a second user, displaying a first control in a task interface of the first user comprises: in response to the first user having a permission to the task information, displaying the first control in the task interface of the first user. in some embodiments, displaying the task information in the task sub-interface comprises: in response to the first user having a permission to the task information, displaying the task information in the task sub-interface.

Further, the present disclosure also provides a terminal, comprising: at least one memory and at least one processor; wherein the at least one memory is for storing program code, the at least one processor is for calling the program code stored in the at least one memory to perform the above method of information processing.

Further, the present disclosure also provides a computer storage medium, the computer storage medium stores program code for performing the above method of information processing.

The method and apparatus of information processing of the present disclosure are descried based on embodiments and application examples in the above. Further, the present disclosure also provides a terminal and a storage medium which will be described in the following.

Referring now to FIG. 4, which shows a schematic structural diagram of an electronic device 700 suitable for implementing the embodiments of the present disclosure. The terminal device in the embodiments of the present disclosure may include, without limitation to, a mobile terminal such as a mobile phone, a laptop computer, a digital broadcast receiver, a PDA (personal digital assistant), a PAD (tablet computer), a PMP (portable multimedia player), an on-board terminal (e.g., on-board navigation terminal) and the like, as well as a fixed terminal such as a digital TV, a desktop computer and the like. The electronic device shown in FIG. 4 is merely an example and should not be construed to impose any limitations on the functionality and use scope of the embodiments of the present disclosure.

As shown in FIG. 4, the electronic device may comprise processing apparatus (e.g., a central processor, a graphics processor) 701 which is capable of performing various appropriate actions and processes in accordance with programs stored in a read only memory (ROM) 702 or programs loaded from a storage device 708 to a random access memory (RAM) 703. In the RAM 703, there are also stored various programs and data required by the electronic device 700 when operating. The processing device 701, the ROM 702 and the RAM 703 are connected to one another via a bus 704. An input/output (I/O) interface 705 is also connected to the bus 704.

Usually, the following means may be connected to the I/O interface 705: an input device 706 including a touch screen, a touch pad, a keyboard, a mouse, a camera, a microphone, an accelerometers, a gyroscope, or the like; an output device 707, such as a liquid-crystal display (LCD), a loudspeaker, a vibrator, or the like; and a communication device 709. The communication device 709 allows the electronic device 700 to perform wireless or wired communication with other device so as to exchange data with another device. While FIG. 4 shows the electronic device 700 with various means, it should be understood that it is not required to implement or have all of the illustrated means. Alternatively, more or less means may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication device 709, or installed from the storage device 708, or installed from the ROM 702. The computer program, when executed by the processing apparatus 701, perform the above functions defined in the method of the embodiments of the present disclosure.

It should be noted that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium including or storing a program that may be used by or in conjunction with an instruction executing system, apparatus or device. In the present disclosure, the computer readable signal medium may include data signals propagated in the baseband or as part of the carrier waveform, in which computer readable program code is carried. Such propagated data signals may take a variety of forms, including without limitation to electromagnetic signals, optical signals, or any suitable combination of the foregoing. The computer readable signal medium may send, propagate, or transmit a program for use by, or in conjunction with, an instruction executing system, apparatus, or device. The program code contained on the computer readable medium may be transmitted by any suitable medium, including, but not limited to, a wire, a fiber optic cable, RF (radio frequency), etc., or any suitable combination thereof.

In some implementations, clients and servers can communicate using any currently known or future developed network protocol such as HTTP (HyperText Transfer Protocol) and can interconnect with any form or medium of digital data communication (such as communication networks). Examples of communication networks include local area networks (“LANs”), wide area networks (“WANs”), internets (such as the Internet), and end-to-end networks (such as ad hoc end-to-end networks), as well as any currently known or future developed networks.

The computer readable medium mentioned above can be included in the electronic device mentioned above; it can also exist separately without being assembled into the electronic device.

The computer readable medium carries one or more programs. When one or more programs are executed by the electronic device, cause the electronic device to perform the method of the present disclosure.

Computer program code for carrying out operations of the present disclosure may be written in one or more program designing languages or a combination thereof, which include without limitation to an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the present disclosed embodiment can be implemented through software or hardware. Among them, the name of the unit does not constitute a qualification for the unit itself in a certain situation.

The functions described above in this article can be at least partially executed by one or more hardware logic components. For example, non-limiting examples of hardware logic components that can be used include: Field Programmable Gate Arrays (FPGAs), Application Specific Integrated Circuits (ASICs), Application Specific Standard Products (ASSPs), On Chip Systems (SOC), Complex Programmable Logic Devices (CPLDs), and so on.

In the context of this disclosure, machine readable media can be tangible media that can contain or store programs for use by or in combination with instruction execution systems, devices, or devices. A machine readable media can be machine readable signal media or machine readable storage media. A machine readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

According to one or more embodiments of the present disclosure, a method of information processing is provided. The method of information processing comprises: in response to a first user receiving an association request for task information of a second user, displaying a first control in a task interface of the first user; and in response to a first predetermined operation on the first control, displaying a task sub-interface.

According to one or more embodiments of the present disclosure, task information is displayed in the task sub-interface, the task information comprising objective task information and/or sub-task information, and the objective task information having an association relationship with the sub-task information.

According to one or more embodiments of the present disclosure, the task information comprises a first user identification.

According to one or more embodiments of the present disclosure, the first control is displayed in a predetermined region of the task interface, and the first control is associated with the objective task information of the first user.

According to one or more embodiments of the present disclosure, the first control uniquely corresponds to the objective task information of the first user.

According to one or more embodiments of the present disclosure, when receiving an association request related to the objective task information, the objective task information is displayed in the task sub-interface; or, when receiving an association request related to the sub-task information, the sub-task information is displayed in the task sub-interface, and the objective task information having the association relationship with the sub-task information is displayed.

According to one or more embodiments of the present disclosure, a second control corresponding to the task information is further displayed in the task sub-interface.

According to one or more embodiments of the present disclosure, further comprising: when receiving an association request related to the objective task information, displaying the second control in an association region of the objective task information in the task sub-interface; or, when receiving an association request related to the sub-task information, determining the objective task information having the association relationship with the sub-task information, and displaying the second control in the association region of the objective task information of the task sub-interface.

According to one or more embodiments of the present disclosure, the task information comprises objective task information and/or sub-task information, the method further comprising: in response to the task information of the second user having been associated with a first objective task information of the first user, forgoing displaying the task information of the second user in task sub-interface corresponding to the first objective task information.

According to one or more embodiments of the present disclosure, further comprising: determining second objective task information of the first user that is unassociated with the task information of the second user, and displaying the task information of the second user in task sub-interface corresponding to the second objective task information.

According to one or more embodiments of the present disclosure, in response to a second predetermined operation on the second control, displaying the task information in the task sub-interface is terminated.

According to one or more embodiments of the present disclosure, a third control corresponding to the second user is displayed in the task sub-interface.

According to one or more embodiments of the present disclosure, in response to a third predetermined operation on the third control, displaying the task information of the second user in the task sub-interface is terminated.

According to one or more embodiments of the present disclosure, predetermined information corresponding to the number of pieces of task information displayed in the task sub-interface is further displayed near the first control.

According to one or more embodiments of the present disclosure, the task information comprises objective task information and/or sub-task information, the objective task information having an association relationship with the sub-task information; the method further comprises: determining whether the objective task information and sub-task information contain an association request; determining the predetermined information based on the number of pieces of the objective task information containing the association request; or, determining the predetermined information based on the number of pieces of objective task information associated with the sub-task information containing the association request.

According to one or more embodiments of the present disclosure, when the task information is not contained in the task sub-interface, the task sub-interface is closed, and the first control is not displayed in the task interface.

According to one or more embodiments of the present disclosure, in response to a first user receiving an association request for task information of a second user, displaying a first control in a task interface of the first user comprises: in response to the first user having a permission to the task information, displaying the first control in the task interface of the first user.

According to one or more embodiments of the present disclosure, displaying the task information in the task sub-interface comprises: in response to the first user having a permission to the task information, displaying the task information in the task sub-interface.

According to one or more embodiments of the present disclosure, an apparatus of information processing is provided. The apparatus comprises: a control display module configured to in response to a first user receiving an association request for task information of the second user, display a first control in a task interface of the first user; and an interface display module configured to in response to a first predetermined operation on the first control, display a task sub-interface.

According to one or more embodiments of the present disclosure, a terminal is provided. The terminal comprises: at least one memory and at least one processor; wherein the at least one memory is for storing program code, the at least one processor is for calling the program code stored in the at least one memory to perform the method according to any one of the above.

According to one or more embodiments of the present disclosure, there is provided a storage medium for storing program code for performing the method described above.

The above description is only a preferred embodiment of this disclosure and an explanation of the technical principles used. Those skilled in the art should understand that the scope of disclosure involved in the present disclosure is not limited to technical solutions formed by specific combinations of the aforementioned technical features, but also covers other technical solutions formed by any combination of the aforementioned technical features or their equivalent features without departing from the disclosed concept. For example, a technical solution formed by replacing the above features with (but not limited to) technical features with similar functions disclosed in this disclosure.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure. Certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of information processing, comprising:
in response to a first user receiving an association request for task information of a second user, displaying a first control in a task interface of the first user; and
in response to a first predetermined operation on the first control, displaying a task sub-interface.

2. The method of information processing of claim 1, wherein task information is displayed in the task sub-interface, the task information comprising objective task information and/or sub-task information, and the objective task information having an association relationship with the sub-task information.

3. The method of information processing of claim 1, wherein the task information comprises a first user identification.

4. The method of information processing of claim 2, wherein the first control is displayed in a predetermined region of the task interface, and the first control is associated with the objective task information of the first user.

5. The method of information processing of claim 2, wherein the first control uniquely corresponds to the objective task information of the first user.

6. The method of information processing of claim 2, wherein,
in response to receiving an association request related to the objective task information, the objective task information is displayed in the task sub-interface: or,
in response to receiving an association request related to the sub-task information, the sub-task information is displayed in the task sub-interface, and the objective task information having the association relationship with the sub-task information is displayed.

7. The method of information processing of claim 2, wherein a second control corresponding to the task information is further displayed in the task sub-interface.

8. The method of information processing of claim 7, further comprising:
in response to receiving an association request related to the objective task information, displaying the second control in an association region of the objective task information in the task sub-interface; or,
in response to receiving an association request related to the sub-task information, determining the objective task information having the association relationship with the sub-task information, and displaying the second control in the association region of the objective task information of the task sub-interface.

9. The method of information processing of claim 1, wherein the task information comprises objective task information and/or sub-task information, the method further comprising:
in response to the task information of the second user having been associated with a first objective task information of the first user, forgoing displaying the task information of the second user in task sub-interface corresponding to the first objective task information.

10. The method of information processing of claim 9, further comprising:
determining second objective task information of the first user that is unassociated with the task information of the second user, and displaying the task information of the second user in task sub-interface corresponding to the second objective task information.

11. The method of information processing of claim 7, wherein in response to a second predetermined operation on the second control, displaying the task information in the task sub-interface is terminated.

12. The method of information processing of claim 1, wherein a third control corresponding to the second user is displayed in the task sub-interface.

13. The method of information processing of claim 12, wherein in response to a third predetermined operation on the third control, displaying the task information of the second user in the task sub-interface is terminated.

14. The method of information processing of claim 1, wherein predetermined information corresponding to the number of pieces of task information displayed in the task sub-interface is further displayed near the first control.

15. The method of information processing of claim 14, wherein the task information comprises objective task information and/or sub-task information, the objective task information having an association relationship with the sub-task information; the method further comprises:
determining whether the objective task information and sub-task information contain an association request;
determining the predetermined information based on the number of pieces of the objective task information containing the association request: or,
determining the predetermined information based on the number of pieces of objective task information associated with the sub-task information containing the association request.

16. The method of information processing of claim 1, wherein when the task information is not contained in the task sub-interface, the task sub-interface is closed, and the first control is not displayed in the task interface.

17. The method of information processing of claim 1, wherein the in response to a first user receiving an association request for task information of a second user, displaying a first control in a task interface of the first user comprises:
in response to the first user having a permission to the task information, displaying the first control in the task interface of the first user.

18. The method of information processing of claim 2, wherein displaying the task information in the task sub-interface comprises:
in response to the first user having a permission to the task information, displaying the task information in the task sub-interface.

19. (canceled)

20. A terminal, comprising:
at least one memory and at least one processor;
wherein the at least one memory is for storing program code, the at least one processor is for calling the program code stored in the at least one memory to:
in response to a first user receiving an association request for task information of a second user, display a first control in a task interface of the first user; and
in response to a first predetermined operation on the first control, display a task sub-interface.

21. A non-transitory storage medium for storing program code, the program code for performing:
in response to a first user receiving an association request for task information of a second user, displaying a first control in a task interface of the first user; and
in response to a first predetermined operation on the first control, displaying a task sub-interface.
